(19) United States
(12) Patent Application Publication
(10) Pub. No.: US 2008/0086305 A1
(43) Pub. Date: Apr. 10, 2008

(54) Digital dictation workflow system and method

(75) Inventors: Simon John Lewis, Kent (GB); Jonathan Mark Isherwood Carter, Kent (GB); Marc Stuart Harris, London (GB); William John Haig Richardson, Essex (GB); Graham Wright, London (GB); Martin James Colin Hughes, Middlesex (GB); Paul Pastura, London (GB)

Correspondence Address: DRINKER BIDDLE & REATH (DC), 1500 K STREET, N.W., SUITE 1100, WASHINGTON, DC, 20005-1209, US

(73) Assignee: BigHand Ltd.

(21) Appl. No.: 11/905,408

(22) Filed: Sep. 28, 2007

Related U.S. Application Data
(60) Provisional application No. 60/848,700, filed on Oct. 2, 2006.

(51) Int. Cl. G10L 15/26

(52) U.S. Cl. 704/235; 704/E15.044

(57) ABSTRACT

A digital dictation workflow system and method employing a plurality of client devices and at least one server. Certain client devices are operable to record audio information dictated by a user for storing as a digital audio file in a file store, and others are operable to receive and reproduce the stored digital audio file as audio. The server is connected to the client devices via a network, and manages storage and retrieval of the digital audio file to and from the file store and the client devices. The system and method further employ at least one database for storing dictation data pertaining to the digital audio file stored in the file store, and can be configured in a three-tier arrangement with the client devices being present in a presentation layer, the server present in a business logic layer, and the file store and database present in a data access layer.

This application claims benefit from U.S. Provisional Patent Application No. 60/848,700 filed on Oct. 2, 2006, the entire content of which is incorporated herein by reference.

### BACKGROUND OF THE INVENTION

1. Field of the Invention

The present invention relates to a digital dictation workflow system and method.

2. Description of the Related Art

Traditionally, magnetic tapes have been used for dictation. Advances in computer and software technology have made it possible to record voice in a computer readable file, such as a .wav file. However, absent dedicated workflow and dictation management software, stand alone digital dictation has negligible advantages over cassette based dictation.

For example, dictation authors may have to copy their dictated files into network folders for access by transcribers. Authors therefore waste time performing “copy and paste” file management operations, and transcribers need permission to view the folders. Also, it may be difficult to determine which files have been transcribed, and anybody can listen to or delete dictations since there generally are no confidential options or password protection. Furthermore, the need for file replication increases, since information technology (IT) staff has to manage a complicated system of folders and permissions.

Alternatively, if the authors use email to distribute their dictation files, the authors typically must create mail, locate and attach files, choose recipients, send the mail and then wait for the file to be transcribed. However, the transcriber may be away, causing a delay. Also, transcribers may need access to each other's inboxes. The author is unable to monitor the status of the dictation, and the system is inherently insecure.

In another scenario, authors can physically transfer memory cards to transcribers. However, several disadvantages exist with this methodology. For example, memory cards are smaller and easier to lose than cassettes, dictation files will not be backed up, all transcribers need card readers, and all authors typically would need several memory cards. Hence, memory cards provide little if any advantage over cassettes. Also, in all of the above scenarios, time is wasted on walking about and telephoning to check the progress of the transcription, since there is no monitoring of status.

### BRIEF DESCRIPTION OF THE DRAWINGS

These and other objects, advantages and novel features of the invention will be more readily appreciated from the following detailed description when read in conjunction with the accompanying drawings, in which:

FIG. 1 is a conceptual diagram illustrating an example of a system for performing digital dictation according to an embodiment of the present invention;

FIG. 2 is a conceptual diagram illustrating an example of a system for performing digital dictation according to another embodiment of the present invention;

FIGS. 3-5 are conceptual diagram illustrating an example of different layers of the systems shown in FIGS. 1 and 2;

FIG. 6 is an example of a workflow window that can be displayed by monitor screens of certain of the devices of the systems shown in FIGS. 1 and 2;

FIG. 7 is a conceptual diagram illustrating an example of a virtual firewall in the systems shown in FIGS. 1 and 2;

FIG. 8 is an example of a network access window that can be displayed by monitor screens of certain of the devices of the systems shown in FIGS. 1 and 2;

FIG. 9 is an example of an active directory that can be displayed by monitor screens of certain of the devices of the systems shown in FIGS. 1 and 2;

FIG. 10 is an example of a work administration directory that can be displayed by monitor screens of certain of the devices of the systems shown in FIGS. 1 and 2;

FIG. 11 is an example of a work in progress window that can be displayed by monitor screens of certain of the devices of the systems shown in FIGS. 1 and 2;

FIG. 12 is an example of a dictation window that can be displayed by monitor screens of certain of the devices of the systems shown in FIGS. 1 and 2;

FIG. 13 is an example of a document profile window that can be displayed by monitor screens of certain of the devices of the systems shown in FIGS. 1 and 2;

FIGS. 14-16 are examples of additional workflow and file management windows that can be displayed by monitor screens of certain of the devices of the systems shown in FIGS. 1 and 2;

FIG. 17 is a conceptual diagram of a telephone keypad for use in telephone access of the systems show in FIGS. 1 and 2 according to an embodiment of the present invention;

FIGS. 18-20 are conceptual diagrams illustrating examples of file backup arrangements for the systems shown in FIGS. 1 and 2;

FIG. 21 is a conceptual diagram illustrating an example of email routing of a dictation file in the systems shown in FIGS. 1 and 2 according to an embodiment of the present invention;

FIG. 22 is an example of a window for use with the email routing of a dictation file as shown in FIG. 21;

FIG. 23 is an example of a directory displayed by the systems shown in FIGS. 1 and 2 according to an embodiment of the present invention;

FIGS. 24-26 are examples windows relating to reports that can be generated by the systems shown in FIGS. 1 and 2 according to an embodiment of the present invention; and

FIGS. 27-31 are examples windows relating to priorities and alerts that can be generated by the systems shown in FIGS. 1 and 2 according to an embodiment of the present invention.

### DETAILED DESCRIPTION OF THE PREFERRED EMBODIMENTS

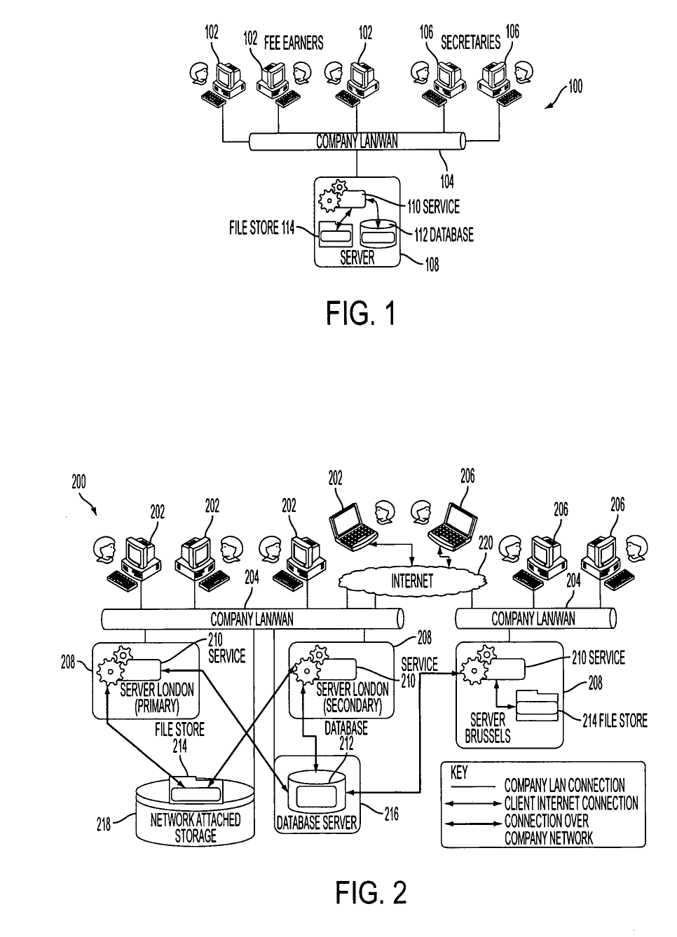

FIG. 1 is a conceptual block diagram illustrating an example of a system 100 capable of supporting a digital dictation workflow system according to an embodiment of the present invention. In this example, the system 100 is configured as a three-tier client-server-database system for the management of workflow between authors and transcribers of digital dictation audio files. In particular, fee earners, such as attorneys, can access the digital dictation workflow system via dictation devices 102 which, in this example, can be desktop or laptop computers with hand-held dictation devices, running digital dictation software according to an embodiment of the present invention.

The dictation devices 102 communicate with, for example, a network 104, such as a local access network (LAN) or wide area network (WAN), or any other suitable network such as an intranet or the Internet. A plurality of transcription devices 106, such as computers used by secretaries or word processing personnel, can also access and thus communicate with the network 104 to receive the digitally dictated files transferred to the network 104 from the dictation devices 102 as discussed in more detail below. The devices 102 and 106 can be referred to “client devices.” Again, the client devices 102 and 106 can be PCs, laptops or terminals, and their specifications and operability depend upon the environments in which they will be used.

The network 104 further communicates with a server 108 that runs software 110, such as an application service, according to an embodiment of the present invention, and can include, for example, a structured query language (SQL) database 112 and file store 114 for storing digital dictation files or transcribed files and any other information as discussed in more detail below. Specifically, dictation files can be created on the dictation devices 102, which are considered part of the “client system”, and uploaded via the network 104 to the server 108. The software application service 110 manages the file store 114 and the SQL database 112, which may be housed on the same server 108 or separately.

As shown in FIG. 2, the system 100 can be configured as system 200 including dictation devices 202, networks 204 and transcription devices 206 similar to dictation devices 102, networks 104 and transcription devices 106 discussed above. However, in this arrangement, the system 200 can include a plurality of servers 208 each running software application service 210 according to an embodiment of the present invention. In this configuration, the SQL database 212 can be hosted on a dedicated server 216 and the file store 214 can be housed in a dedicated storage device 218, as well as on a server 208 (e.g., the Brussels server). Also, any of the client devices, such as the dictation devices 202 and transcription devices 206, can access the networks 204 via the Internet 220.

As can be appreciated from the above example, the systems 100 or 200 employ at least one server and at least one client device, although in practice a server can be present in each geographic location in which a company or organization has an office, and a separate database and/or file store can be used. The systems 100 and 200 in these examples can use the Windows Server operating system software and the Microsoft MSSQL database management software to implement the server side feature. As discussed in more detail below, the systems 100 and 200 can employ optional modules which provide additional remote working features, such as telephony dictation or email submission, or allow for the system 100 and 200 and, in particular, their client devices 102, 202, 106 and 206, to integrate with third party applications.

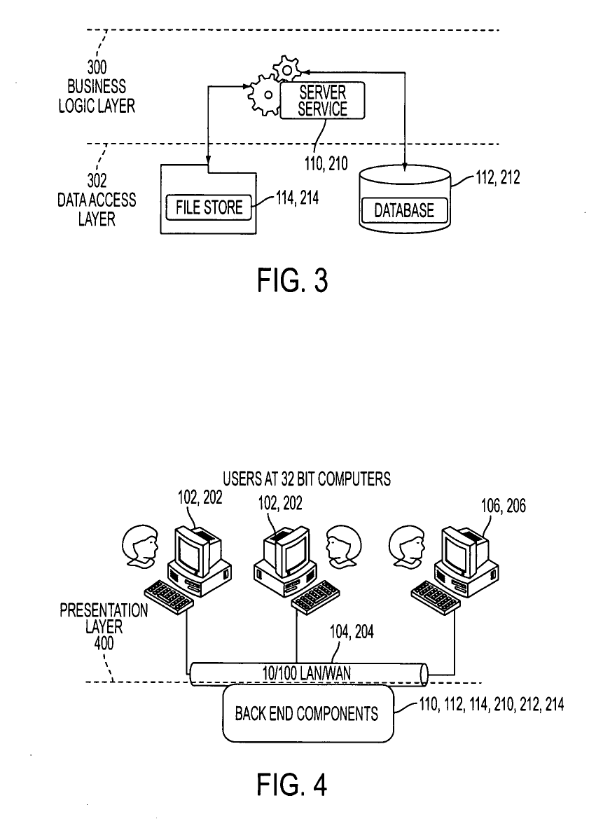

FIG. 3 is a conceptual diagram illustrating an example of the three tier architecture of the systems 100 and 200 in which all three tiers, or layers, contribute to the operation of the systems. The business logic layer 300 and data access layer 302 are collectively referred to as the ‘back end’ of the systems 100 and 200. As discussed above, the back end components include the software application service 110 and 210, database 112 and 212, and file store 114 and 214, as shown in FIGS. 1 and 2. It should be noted that in some cases, the server 108 or 208, file store 114 or 214 and database 112 and 212 may be installed on the same physical server, and little space is required for the server service 110 and 210 itself. An Advanced Micro Devices (AMD), Cyrix or equivalent processors are acceptable for use in the physical server. Software features can include telephony, Citrix and Terminal Services, Web, Device Sync, XP style Interface, Advanced Reporting, Advanced Sound CoDec (incorporates Granular resynthesis, Pitch control, Rumble filter), Advanced Security, Hot key control, Drag n' Drop, Speech Recognition option and software SDK integrations.

Server

Table 1 below sets forth an example of requirements for server 108 or 208 according to an exemplary embodiment of the present invention.

TABLE 1

| Exemplary Server | Exemplary | Exemplary |
|---|---|---|
| Requirements | Minimum | Recommended |
| Operating System | Win 2000 SP3 | WIN 2003 SP1 |
| Processor type | Pentium III 500 | Dual Xeon 3.6 Ghz |
| and speed (MHz) | | 800 MHz FSB or higher |
| RAM (GB) | 1 GB | 2 GB |
| Hard Disk Space (MB) | 200 MB | 500 MB |
| Internet Explorer | IE 6.0 | IE 6.0 |
| Network Card (Mbps) | 10/100 | 10/100/1000 |

It is noted that a client device (e.g., 106 or 206) does not need to continuously poll the server 108 or 208 all the time for new dictations, views, etc. Rather, the server 108 or 208 knows exactly what the client device knows and when there is a change, and the server 108 or 208 sends down an update which minimizes network traffic. It is not necessary for the server 108 or 208 to send a full description of what the user can see. This makes the software more scalable, and updates to the client devices can occur much more quickly and efficiently.

It should also be noted that the software application service 110 and 210 is intelligent software responsible for entering dictation data into the database 112 or 212 and for copying the dictation audio files to the file store 114 or 214. All access to the file store 114 or 214 and the database 112 or 212 is controlled by the software application service 110 or 210, which can be at a primary software source and a backup software source. A client device (e.g., 102, 106, 202 or 206) does not have any direct access to the database 112 or 212 or file store 114 or 214, creating a virtual firewall leading to a very secure system with resilience and redundancy. The software application service 110 or 210 also ensures that client devices only pick up changes of data from the database 112 or 212, thus enabling queries to run faster and use less network bandwidth.

Furthermore, the software application service 110 or 210 can use a single executable for all types of users (fee earner, secretary, work administrator, system administrator). Hence, there is no need for different installation for different profiles, which increases speed of installation and ease of support. In addition, no permanent connection need be kept to the database 112 or 212. Rather, a TCP/IP connection, for example, is established with the software application service 110 or 210. When not connected, a client device 102 or 202 can store dictations in the Outbox which are sent automatically when a network connection is made.

As discussed in more detail below, the server 108 or 208 can control workflow via an in-built “Workflow Wizard” and can set advanced file storage and access rules. The software application service 110 or 210 can also employ a custom system performance monitor counter to provide information about the operational performance of the system 100 or 200, allowing faster diagnosis of problems and technical support. Events can be written to an event log, thus allowing reporting of important/primary events to network operators, for example. The server 108 and 208, and the software application service 110 and 210, allow for “drag & drop” capabilities so that, for example, when fee earners, trainees or secretaries move department, they can just drag and drop multiple users and all their work moves with them. The servers 108 and 208 and software application service 110 and 210 also provide for a full audit trail showing everything that has happened to a dictation, as well as automatic fail over and fail back operation via backup server features. In addition, all editable text, such as priority and state definitions, can be stored in the database 112 or 212 by language, which allows quick language switching.

As discussed briefly above, the server technology can also be used on Citrix MetaFrame 1.8, XP1.0, MPS3.0 and Windows Terminal Services server centric environments, such as Windows NT4 SP6a, Windows 2000 or Windows 2003. The software application service 110 and 210 has been designed to speed up database query processing, while using less network bandwidth. As such, fee earners will not be subject to annoying delays or “hanging”, which allows for “dictate & go” capabilities.

File Store

Table 2 below sets forth an example of an example of requirements for a file store 114 or 214 according to an exemplary embodiment of the present invention.

TABLE 2

| Exemplary File Storage | Exemplary | Exemplary |
|---|---|---|
| Requirement | Minimum | Recommended |
| Operating System | Win 2000 SP3 | WIN 2003 SP1 |
| Processor type | Pentium III 500 | Dual Xeon 3.6 Ghz |
| and speed (MHz) | | 800 MHz FSB or higher |
| Memory (GB) | 1 GB | 2 GB |
| Hard Disk Space (MB) | See notes below | See notes below |
| Internet Explorer | IE 6.0 | IE 6.0 |
| Network Card (Mbps) | 10/100 | 10/100/1000 |

Notes Pertaining to the File Store

A Storage Area Network/Network Attached Storage (SAN/NAS) and UNIX file store can be used. AMD, Cyrix or equivalent processors are acceptable. The storage requirement (hard disk space) is a function of the number and size of the files stored, as well as the length of time for which they are stored. When estimating file store requirements, one would first estimate the average duration of dictation per user per day, as well as the number of users. By default, the file store can retain dictations for 7 days after completion and ten minutes of dictation will require about 1.14 MB of storage space. The following exemplary formula can be used to estimate storage requirement:
Storage requirement (MB)=7×0.114×Number of Users×Avg. Dictation duration per day (minutes)

As stated, in this example, 0.114 MB is used per minute of dictation, and 7 days is the default time to store dictations. This storage time can be changed, as desired. Accordingly, if dictations are kept in a file store for 7 days and one author creates 10 dictations of 10 minutes each per day, the minimum storage requirement is 700 minutes. The equivalent file store size is approximately 80 MB when using a high quality codec in this example.

It should also be noted that the dictation file store 114 or 214 is typically located at an area on the system 100 or 200 that can be configured so it is only accessible by the software application service 110 or 210. A benefit of this (over storing dictation audio files in a database) is that it keeps database utilization to a minimum and allows the dictation files to be stored on any appropriate server (e.g., Unix, Netware, NT, 2000) or through a SAN/NAS.

Database

Table 3 below sets forth an example of an example of requirements for a database 112 or 212 according to an exemplary embodiment of the present invention.

TABLE 3

| Exemplary Database | Exemplary | Exemplary |
|---|---|---|
| Server Requirement | Minimum | Recommended |
| Operating System | Win 2000 SP3 | WIN 2003 SP1 |
| MSSQL Server | MSDE2000 or Microsoft | MSSQL Server |
| Version | SQL Server Express | 2000SP3a or |
| | Edition | MSSQL Server 2005 |
| Processor type | Pentium III 500 | Dual Xeon 3.6 Ghz |
| and speed (MHz) | | 800 MHz FSB or |
| | | higher |
| Memory (GB) | 1 GB | 2 GB |
| Network Card (Mbps) | 10/100 | 10/100/1000 |

Notes Pertaining to the Database

Because the Microsoft SQL Server Desktop Engine MSDE (e.g., MSDE 2000) and SQL Server Express Edition (e.g., SQL 2000) are limited with respect to scalability, an MS SQL server is used for systems with more than 50 users or any more than one geographic location. If the software application service 110 or 210 and the database management system are installed on the same server, a minimum of, for example, 2 GB RAM can be used to suffice for the shared server.

In summary, the database 112 or 212 is used to store dictation metadata (author, time, priority, workflow relationship) and software application service 110 and 210 to control the upload and download of dictation audio files between authors, such as lawyers, and transcribers, such as secretaries or word processing support personnel. Dictation audio files themselves in this example are not stored in the database 112 or 212. For database redundancy purposes, multiple databases 112 or 212 with replication can also be implemented across a LAN or sufficiently fast WAN. For example, a London-based database can replicate to a remote site in Birmingham, another to a remote site in Sheffield. Lawyers or secretaries have complete freedom to move office or even country without loss of efficiency, data or functionality. Information is shared at a software application service level, allowing dictations to be visible across sites, and providing load balancing across servers. In addition, XML technology called “the XML database” allows for an essentially “crash resistant” environment.

Thick Client Environment

A thick client environment can be a common implementation of an embodiment of the present invention. In this environment, the presentation layer of the architecture is provided by a thick client that resides, for example, on a Windows desktop or laptop computer, as shown in FIG. 4. In addition to the essential back end components, this environment employs a 10/100 local area/wide area network and computers for users. The client computers 102, 106, 202 and 206 in this environment can comply with the exemplary specifications shown in the Table 4.

TABLE 4

| Exemplary Thick | Exemplary | Exemplary |
|---|---|---|
| client PC Requirement | Minimum | Recommended |
| Operating System | Win 2000 SP3 | WIN XP Pro Sp2 |
| Processor type | Pentium III 500 | Pentium IV 2 GHz |
| and speed (MHz) | | or higher |
| RAM (MB) | 128 | 512 |
| Hard Disk Space (MB) | 100 | 200 |
| Sound Card | Analog sound card | Analog sound card |
| USB Port | USB 1.0 | USB 2.0 |
| Internet Explorer | IE 6.0 | IE 6.0 |
| Network Card (Mbps) | 10/100 | 10/100/1000 |
| Serial Port | RS232 | RS232 |
| Remote Connection | 56 Kbps | 128 Kbps or higher |
| Speed | | (ISDN, DSL, Frame |
| | | Relay, T1) |

Notes Pertaining to the Thick Client Environment

AMD, Cyrix or equivalent processors are acceptable. The hard disk space requirement is based on an estimated average number of author dictations. Work administrator machines employ the recommended specification. Users that require the reporting function of the system 100 or 200, as discussed in more detail below, have Microsoft Excel installed, such as Excel 2000 or later. A sound card is used if the user has a serial interface device such as a serial Philips Speechmike, headset microphone or a secretarial headset. A USB port is employed if the user has a USB device such as a USB Philips Speechmike, a mobile dictation device or USB foot pedal. A remote connection can be employed if the users are working outside of the company LAN. The embodiments of the present invention described herein support remote connection over dial-up networking (DUN), virtual private network (VPN), Citrix or Windows Terminal Services, to name a few.

The following interface devices are currently supported by the thick client software according to an embodiment of the present invention:

Olympus DS range of mobile dictation devices: 330, 660, 2200, 2300, 3000, 3300, 4000;

Philips DPM range of mobile dictation devices: 9220, 9250, 9350, 9360, 9400i, 9450 (US & UK versions);

Grundig Digta range of mobile dictation devices: 4015

Philips desk microphones: Speechmike Pro (USB & Serial), SpeechMike Classic (USB & Serial), Speechmike Classic (US version), Speechmike II Pro, Speechmike II Classic, Speechmike II Classic (International);

Footpedals: Philips Game port foot pedal, Philips USB foot pedal, BigHand Serial Footpedal;

Headsets that utilize a 3.5 mm jack, including Plantronics Audio 20, H91 headsets, Philips Wishbone, Deluxe or Stethoscope headsets and Olympus single piece earphones.

Thin Client Environment

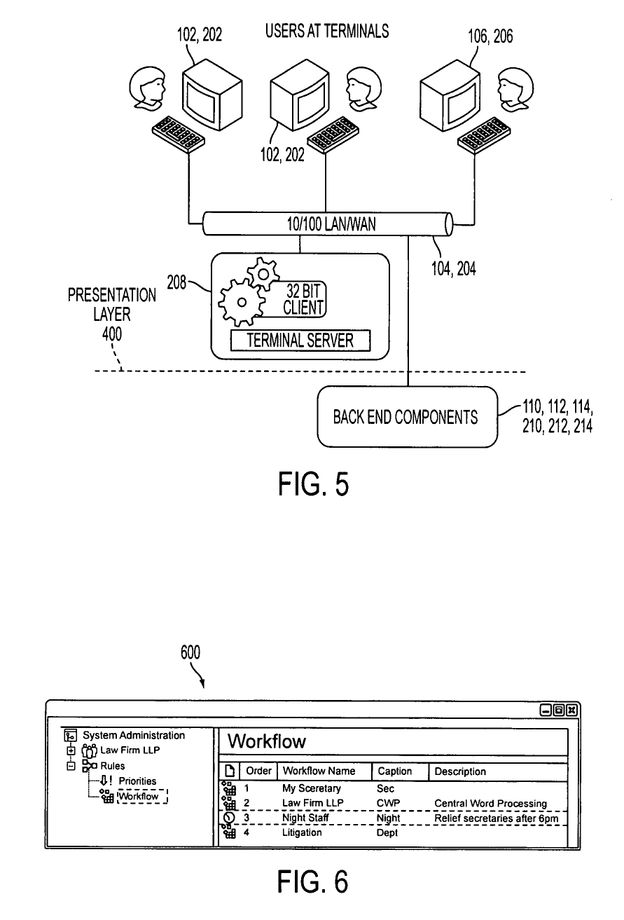

In a thin client environment, the client software is presented to the user on a lower specification computer or terminal, as shown in FIG. 5. In this case, the minimum software resides on the user's terminal and the majority of the application software is served by the terminal server 108 or 208. A thin client environment includes the essential back end components as discussed above, as well as the following: One or more terminal server/s (Citrix or Windows Terminal Services) and/or Low specification desktop computers or terminals.

The following sections describe examples of terminal servers and their respective exemplary characteristics

Windows Terminal Server

Table 5 outlines an example of details of a Windows Terminal Server used to present the client to a network of Windows terminals:

TABLE 5

| Exemplary Windows | | |
|---|---|---|
| Terminal server | Exemplary | Exemplary |
| requirement | Minimum | Recommended |
| Operating System | MS Windows 2000 | Windows 2003 Server |
| | Server (SP3) | (SP1) |
| Additional bandwidth | 2.3 kB/s | 7.1 kB/s |
| per active user | 18.4 kbps | 56.8 kbps (recorded |
| | | values) |

| | |
|---|---|
| Clients | Win 32 bit, TS Web client, MMC |
| Protocol | RDP5 |

Notes Pertaining to Windows Terminal Server

In this example, the average required bandwidth by the dictation software when open is negligible. The only significant impact is when the recording dialogue is open. The bandwidth values are shown in kilobytes per second (kB/s) as well as kilobits per second (kbps). The minimum exemplary additional bandwidth required per user assumes that all low bandwidth optimizations are used. In this example, at least 33 kbps of additional bandwidth should be available per active user, although the requirement may be lower in practice. In this example, the software application service 110 or 210 and database 112 or 212 are not installed on the terminal server.

Citrix Server

Table 6 below outlines an example of details the specification of a Citrix Server used to present a client to a network of Citrix terminals.

TABLE 6

| Exemplary Citrix server | Exemplary | Exemplary |
|---|---|---|
| requirement | Minimum | Recommended |
| Operating System | Citrix MetaFrame | Citrix MetaFrame XP SP1 |
| | 1.8 SP3 | Presentation Server 3.0/4.0 |
| Clients | ICA\ICA32 Ver 6.01, 7, 8/ | |
| | ICA Web Ver 6.30, 7, 8, 9 | |
| Protocol | ICA | |
| Additional bandwidth | 2.0 kB/s | 3.3 kB/s |
| per active user | 16.0 kbps | 26.4 kbps (recorded |
| | | values) |

Notes Pertaining to Citrix Server

As discussed above, the average required bandwidth by the dictation software when open is negligible. The only significant impact is when the recording dialogue is open. The bandwidth values are shown in kilobytes per second (kB/s) as well as kilobits per second (kbps). The minimum additional bandwidth required per user assumes that all low bandwidth optimizations are used. In this example, at least 33 kbps of additional bandwidth can be available per active user, although the requirement may be lower in practice. Also in this example, the software application service 110 or 210 and database 112 or 212 are not installed on the Citrix server.

Thin Client on PC

Table 7 below outlines an example of details the specification of a PC to be used as a terminal in a thin client network.

TABLE 7

| Exemplary PC thin client | Exemplary | Exemplary |
|---|---|---|
| requirement | Minimum | Recommended |
| Operating System | Win 2000 SP3 | WIN XP Pro SP2 |
| Processor type | Pentium 133 | Pentium IV 2 GHz |
| and speed (MHz) | | or higher |
| Memory (MB) | 128 | 256 |
| Hard Disk Space (MB) | 100 | 200 |
| Sound Card | Analog sound card | Analog sound card |
| USB Port | USB 1.0 | USB 2.0 |
| Internet Explorer | IE 6.0 | IE 6.0 |
| Network Card (Mbps) | 10/100 | 10/100/1000 |
| Serial Port | RS232 | RS232 |
| Remote Connection | 56 kbps | 128 kbps or higher |
| Speed | | (ISDN, DSL, Frame |
| | | Relay, T1) |

Notes Pertaining to Thin Client on PC

The system 100 or 200 supports remote connection over dial-up networking (DUN), virtual private network (VPN), Citrix or Windows Terminal Services. AMD or Cyrix equivalent processors are acceptable. The hard disk space exemplary requirement is based on an estimated average number of author dictations. Work administrator machines employ the recommended specification. A sound card is used if the user has a serial interface device such as a serial Philips Speechmike, headset microphone or a secretarial headset. A USB port is used if the user has a USB device such as a USB Philips Speechmike, a mobile dictation device or USB foot pedal.

The following interface devices are currently supported by the thin client software:

Olympus DS range of mobile dictation devices: 330, 660

Philips desk microphones: Speechmike Pro (USB & Serial), SpeechMike Classic (USB & Serial), Speechmike Classic (US version), Speechmike II Pro, Speechmike II Classic, Speechmike II Classic (International)

Footpedals: Philips Game port foot pedal, Philips USB foot pedal, Serial Footpedal

Headsets that utilize a 3.5 mm jack, including Plantronics Audio 20, H91 headsets, PhilipsWishbone, Deluxe or Stethoscope headsets and Olympus single piece earphones.

Thin Client on Terminal

Table 8 below outlines an example of details the specification of a terminal to be used in a thin client network.

TABLE 8

| Exemplary Terminal | Exemplary | Exemplary |
|---|---|---|
| requirement | Minimum | Recommended |
| Operating System | XP Embedded | XP Embedded |
| Flash memory (MB) | 128 | 256 |
| Hard Disk Space (MB) | 2 | 5 |
| Sound Card | Analogue sound card | Analogue sound card |
| USB Port | USB 1.0 | USB 2.0 |
| Network Card (Mbps) | 10/100 | 10/100/1000 |
| Serial Port | RS232 | RS232 |

Notes Pertaining to Thin Client on PC

The following interface devices are currently supported by the thin client software:

Olympus DS range of mobile dictation devices: 330, 660

Philips desk microphones: Speechmike Pro (USB & Serial), SpeechMike Classic (USB & Serial), Speechmike Classic (US version), Speechmike II Pro, Speechmike II Classic, Speechmike II Classic (International)

Footpedals: Philips Game port foot pedal, Philips USB foot pedal, Serial Footpedal

Headsets that utilize a 3.5 mm jack, including Plantronics Audio 20, H91 headsets, Philips Wishbone, Deluxe or Stethoscope headsets and Olympus single piece earphones.

Email Gateway Environment

Table 9 below outlines an example of details the specification of a terminal to be used in a thin client network.

TABLE 9

| Exemplary Email gateway | Exemplary | Exemplary |
|---|---|---|
| requirement | Minimum | Recommended |
| Operating System | Win 2000 SP3 | WIN 2003 SP1 |
| Processor type | Pentium III 500 | Pentium IV 2 GHz |
| and speed (MHz) | | or higher |
| Memory (MB) | 512 | 1024 |
| Hard Disk Space (MB) | 10 | 10 |
| Network Card (Mbps) | 10/100 | 10/100/1000 |
| Internet Explorer | IE 6.0 | IE 6.0 |
| Microsoft Exchange | 2000 or above | 2000 or above |
| .Net Framework | 1.1 | 1.1 |

Notes Pertaining to Email Dictation

If users will submit dictations to the system 100 or 200 using email attachments (from any email account), a Microsoft Exchange server and a Net framework are employed. While the email gateway and the dictation file store can be installed on the same server 108 or 208, the file store 114 or 214 can be at a separate location.

Telephony Dictation Environment

Telephony dictation is an optional module, which can employ a telephony server with TAPI card, such as the Intel Dialogic D4PCIUFEU Table 10 below outlines an example of details for a telephony dictation environment.

TABLE 10

| Exemplary Telephony | Exemplary | Exemplary |
|---|---|---|
| server requirement | Minimum | Recommended |
| Operating System | Win 2000 SP3 | WIN 2003 SP1 |
| Processor type | Pentium III 500 | Pentium IV 2 GHz |
| and speed (MHz) | | or higher |
| Memory (MB) | 512 | 1024 |
| Hard Disk Space (MB) | 10 | 10 |
| Network Card (Mbps) | 10/100 | 10/100/1000 |
| Internet Explorer | IE 6.0 | IE 6.0 |
| TAPI Card | Intel Dialogic | Intel Dialogic |
| | D4PCIUFEU | D4PCIUFEU |

Integrated Applications Environment

It should also be noted that the system 100 or 200 can be integrated with a number of document management and related legal software applications, such as those listed in Table 11 below.

TABLE 11

| Exemplary Integrated | Exemplary Additional | Exemplary version |
|---|---|---|
| application and version | software required | required |
| Interwoven 8.0 | .Net framework 1.1 or | BigHand 3 SR4 |
| | later Interwoven API | or later |
| Hummingbird DM5.105 | .Net framework 1.1 or | BigHand 3 SR4 |
| SR4 | later Hummingbird API | or later |
| Visualfiles v02.01.C.05 | .Net framework 1.1 or | BigHand 3 SR4 |
| | | or later |
| | later Visualfiles API | |

Extensions

In addition to the integrated environments listed above, the API (Application Programming Interface) can be used to extend the functionality of the client application, as indicated in Table 12 below.

TABLE 12

| | Exemplary Additional | Exemplary version |
|---|---|---|
| Exemplary extensions | software required | required |
| Physical file | .Net framework 1.1 | BigHand 3 SR3 |
| | or later | or later |
| MRU+ (Most recently | .Net framework 1.1 | BigHand 3 SR3 |
| used matters) | or later | or later |

Examples of the operations and functionality of the features of the systems 100 and 200 as discussed above will now be described. For purposes of example, this discussion will refer to the components of system 200 as shown in FIG. 2. However, it is understood that corresponding components of system 100, or any other suitable arrangements or variations thereof, can be employed to perform the described functionality.

As discussed above, system 200 enables dictations to be transferred or downloaded from dictation devices 202, such as hand-held recording devices or computers, to either terminal servers 208 or client devices 206, such as remote computers, that can connect with a network 204 using, for example, a platform such as a CITRIX access platform, as would be understood by one skilled in the art. The digital dictations can be compressed before being streamed to the terminal server 208 or client device 206 where they are saved. A particular protocol to enable this transfer or downloading can be run on the servers 208 and client devices 202 and 206. The protocol can detect when supported USB recording devices are connected to the client, uploads the dictation from the recording device, compresses the sound file and converts to .BHF format, and splits the file into, for example, 2 Kb blocks which are then streamed to the server 208. The dictation can then be streamed from the server 208 to the client devices 206.

In addition, data about each dictation, such as author, title, recipient and due date, are maintained by the system 200 in, for example, the database 212. The system 200 therefore uses this data to inform all parties of dictation status and to derive meaningful management information. As shown in FIG. 6, a workflow window 600 can be display on any of the client devices 202 or 206, or on a management terminal. As discussed below, the system 200 can also generate a suite of reports and charts to allow for evaluation of the performance of the system 200 and the productivity of its users.

The systems 100 and 200 according to embodiments of the present invention further create relationship-based (send to secretary) and team based workflows (send to typing pool) by default, but allow for the option to edit the defaults or create new workflows. Custom workflows can be established to enable work distribution to virtual teams. For example, assuming there are several typists who are authorized to transcribe confidential letters, but they work in different geographical areas, the system 100 or 200 can create a “confidential” workflow which automatically routes work to all of them, allowing them to share work as a team despite being geographically separate. Confidential workflows ensure that dictations are only routed to authorized transcribers. Client devices (e.g., 202 and 206) typically cannot access the database 212 or the central file store 214. Furthermore, all network communications can be encrypted to the advanced encryption standard (AES) and individual dictations can be protected by passwords.

An example of a process for accessing, dictating and transcribing digital dictation files will now be described.

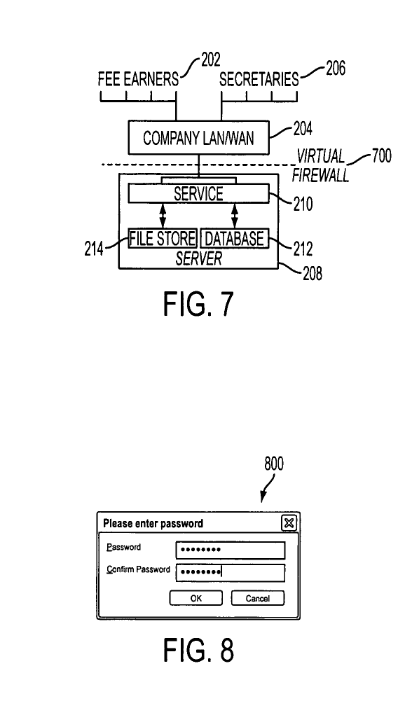

As discussed above, the system 200 (also system 100) employs true three-tier architecture, ensuring the core structure of the software 210 is absolutely secure, resilient and efficient. The server 208 controls all the business logic and, therefore, the client devices 202 and 206 do not require direct access to files or the database 212. This creates a “virtual firewall” 700 providing intrinsic security, as shown in FIG. 7. Users are authenticated via Active Directory or the SQL database. A service account with appropriate permissions runs the service and is the database owner. This account can be the only one requiring special permissions, which is in accordance with industry standard SQL practices.

The software 210 allows for confidential workflows and also password protection in three secure but flexible scenarios:

Confidential send option—a user is assigned group rights that enables them to either submit or retrieve dictations from a ‘Confidential’ folder which allow for the creation of Chinese walls

Password protection function—a fee earner can assign a dictation a file level password, which is then opened by the relevant secretary with the appropriate password. This function can be removed on a user basis.

A combination of a Confidential send option and Password Protection as outlined above.

All dictations can be reallocated or opened by anyone assuming they have the relevant rights, or are in possession of the password. As shown in FIG. 8, a window 800 can be displayed on a client device 202 or 206, to enable a user to access the system 200. Security and permissions can be assigned to group and user ID, in a similar way to group policies in an Active Directory as discussed below. Rights can be assigned to groups to limit the functionality available to the user. These user permissions take effect immediately and control what the user can view and their attributed functions. Access to dictations is assigned by applying permissions to departmental, user folders. These levels help to reduce administrative overhead, ease configuration and encourage minimal training.

As discussed above, the core three-tier architecture and structure of the software is inherently secure by default. The software further uses data hiding so that users cannot see data they are not allowed to access. The system's advanced security also incorporates TCP/IP and file level security and can be fully integrated with an Active Directory allowing added security and shared network login. Other security defaults include local file encryption, and anti-hacking file safeguards locally. Also, the Active Directory process uses, in this example, the Windows SID to authenticate, along with roles-based security in the SQL server. In addition, some registry entries are encrypted.

Furthermore, client-server communication performs initial key exchange using public key encryption and thereafter data is transferred using Rijndael stream encryption, for example. All data cached on the client is saved using, for example, Strong AES encryption. The server 208 can use Windows authentication when connecting to the SQL database, and can receive regular security updates. The system 200 can also comply with BS7799 and ISO17799 security standards.

As can be appreciated, digital dictation files can be transferred in seconds to third parties, thereby creating a much higher risk that they can get into the wrong hands. Privacy, confidentiality and security are paramount to the nature of many businesses, such as law firms. The software 210 therefore is capable of compressing and encrypting a digital dictation file as a special “.bhf” file. A “bhf” file is up to 28 times smaller than standard .wav sound files, enabling network efficiency while retaining sound quality. In this example, the digital dictation file is compressed using an optimized open standard CELP Codec designed explicitly for recording the human voice. The .bhf file is a secure format that offers protection such that if someone external, by accident or malice, obtained a .bhf audio file while it was in the process of being sent or stored, they still could not open and listen to it without the software application service 110.

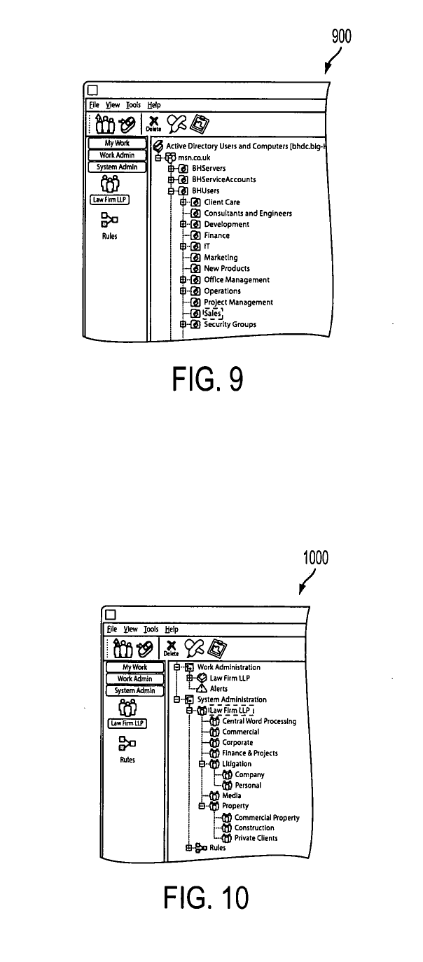

As further discussed, the software has the option to integrate with Active Director, which allows an administrator, for example, to manage your users from his or her directory service and have them imported into the system 200. As shown in FIGS. 9 and 10, the software has also been designed to function to allow for the display of an Active Directory, utilizing hierarchical groups 900 and 1000 for system administration. This ensures all administrative features are intuitive to IT users familiar with Active Directory administration.

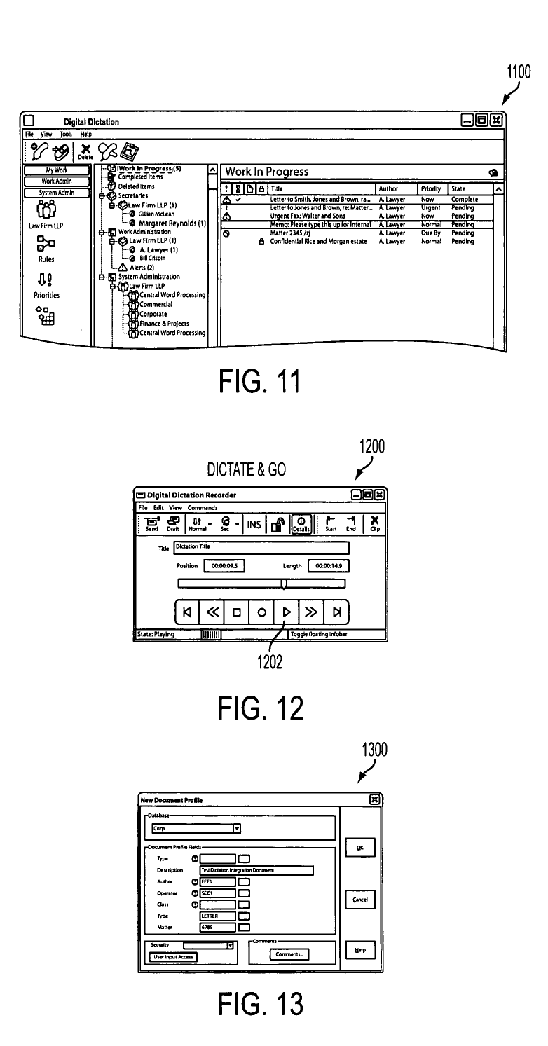

When a user is dictating to a dictation device 202, the audio dictation is written to the local hard disk. When the use clicks “send,” the software 210 checks the database 212 for information relating to the user and then uploads a copy to the file store 214. Uploading occurs, for example, in small pulsed “packets”, consistent with network protocol, and to ensure optimum network efficiency. The software 210 simultaneously or nearly simultaneously enters the dictation information into the database 212 such as author, priority, etc., and automatically checks which transcribers (e.g., secretaries) need to be informed of this information. The software then needs to send the relevant information to only the relevant client devices 206, thus optimizing efficiency. This information can appear in a work list display window 1100, as shown in FIG. 11, for example.

When requested by the transcriber (secretary), the software 210 checks the database 212 for information relating to the dictation, downloads a copy of the dictation to the secretary's device's local hard disk (again using efficient packets), updates the database information as appropriate, and sends out the notification to all relevant clients devices 202 and 206. Subsequent file deletion is managed by the software 210 (for the file stores) and by client devices 202 and 206 for local copies, which creates a very robust and resilient solution.

As can be appreciated, by writing to the local hard disk before uploading to the server 208, there is no need to increase capacity of a LAN network 204 infrastructure since small amounts of data packets are transferred between the client and server after a dictation has been uploaded/download. In addition, if there is a network failure, authors and secretaries alike would still continue working because the dictation is stored locally.

As discussed above, the software 210 can be integrated with basically any API compliant application to produce ‘event driven’ functions using an SDK. The SDK can be implemented using VB, .NET, C++, C#, to name a few. The SDK can include sample code, full documentation, SDK conventions, firing and editing script events, extensibility, Windows client components, script events, and ActiveX controls, among other things. For example, the SDK can configure the system so that a secretary opens a dictation and activates a document template complete with pre-populated metadata, or an author begins a dictation and this starts a time recording system.

During recording, a recording window 1200 as shown in FIG. 12 can be displayed by the computer operating as the dictation device 202, so that the author can enter a title for the dictation, and can use editing buttons 1202 for operations such as fast forward, pause, rewind, play, record and so on, as would be present on a typical dictation device. As shown in FIG. 13, an author can automatically call up a profile box 1300 for a new dictation, and have the resulting document displayed within the work list display window 1100 as shown in FIG. 11. The work in progress list can also be linked to the document itself.

The software 210 can also provide support for multiple international languages, and can integrate into any desired corporate language or languages. Customizable names (e.g. priorities, workflow, states, etc.) can be stored within a “Language Table” in the database 212 which allows easy editing and translation. Menus, messages, and dialogues can be stored, for example, within resource DLL's which enable them to be listed, translated, then restored and configured. Support for a new language not already supplied can be provided by translating menus, dialog boxes and messages into the new language and creating a new resource DLL, and by translating customer defined text such as Priorities, Workflows etc. into the new language and entering them into the database 212. Once entered, the software 210 can use the user's locale to determine the correct language to use.

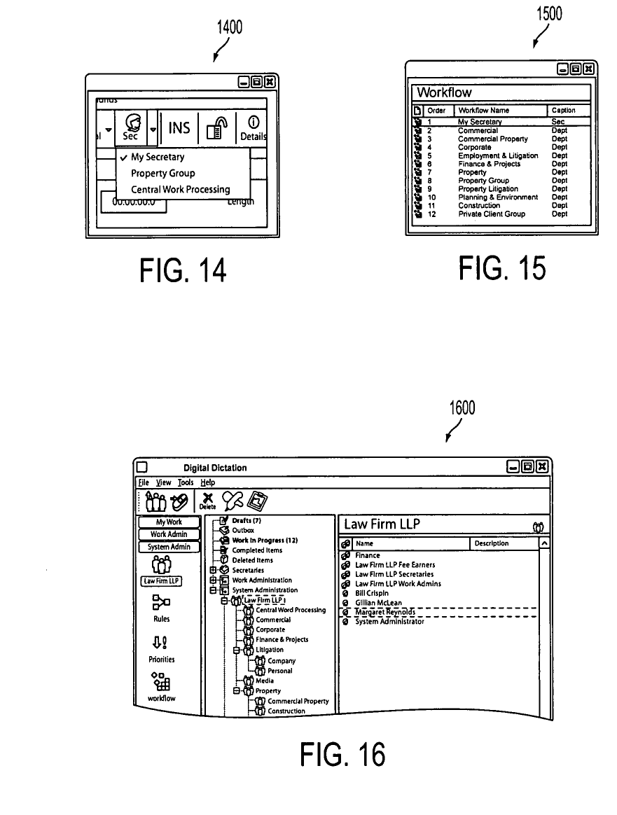

As further shown in FIGS. 14-16, additional workflow windows 1400, 1500 and 1600 can be displayed to allow for an open workflow system. As shown in FIG. 14, for example, which illustrates an example of a drop down menu from the recording window 1200 (see FIG. 12), three sending options are available. The status of a dictation file is continually tracked through the system. A fee earner is able to track the status of the dictation file on screen as it is displayed in the “Work in progress” folder as shown in FIG. 11 and discussed above. A secretarial administrator, for example, can also view all folders and dictations. All tracking and functionality can be accessed from one central user screen with no movement between “pop-up” windows and very little scrolling involved. The status of a dictation file can be visible at all times and can be seen by the person who created the file, the secretary who received it, and, if sent to a department folder, all users with permissions to view that folder. A secretarial coordinator, for example, can monitor all files and dictations, and an author can be automatically notified when a typist completes a dictation. Also, simultaneous workflows can be given to different users and groups.

The software 210 allows for confidential workflows and also password protection, which can allow confidential dictations to sit in team/departmental folders. The Password function allows for confidential files to be protected. Data hiding, together with different levels of administration and user permissions, allow for the creation of Chinese walls.

Telephony features of the system 200 can be used for instant dictation and distribution to a transcriber, such as a secretary, when on the move. Long train journeys, commutes or traveling time between meetings become useful working sessions. The telephony server software can be installed, for example, on a server 208 and configured to communicate with the software 210. As many users as desired can access the telephony system with any touch tone phone, provided that they have been given a 4-digit user ID code and PIN. To achieve this, the system 200 can include a TAPI compliant telephony card, such as an Intel Dialogic card, that is capable of dealing with the number of telephone users that can access the system 200 at any one time. The telephony server software can be compatible with any TAPI compliant telephone system.

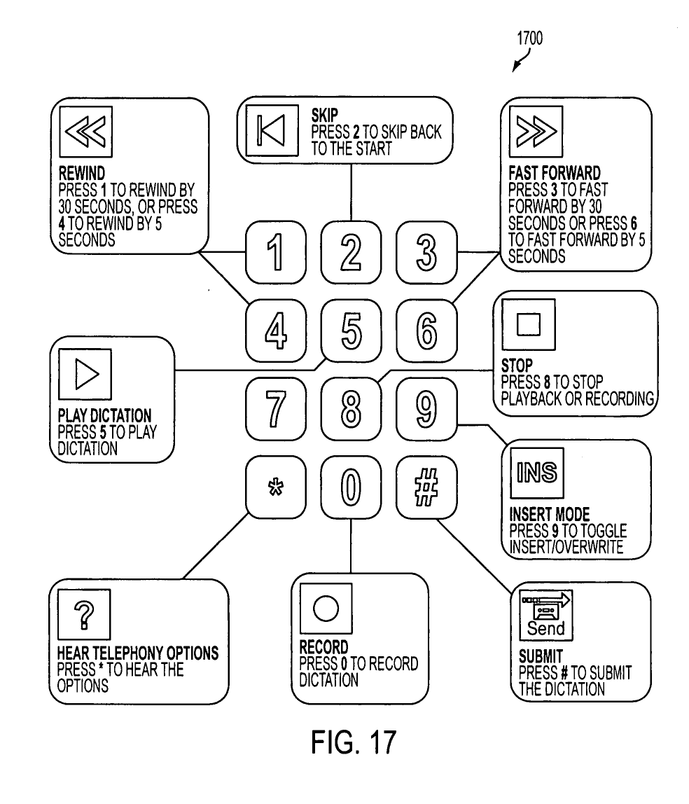

The author can call the telephone number of the organization from any remote location (e.g., from a train), and can then enter a 4-digit user ID code, followed by a 4-digit PIN code. The author then has access to a telephony account and can use the telephone keypad 1700 as in FIG. 17 to control the dictation. In this example, presses 0 to begin recording. Once the dictation is completed, the author can press presses #1 to submit instantly to the office based secretary. Once the author has reached the destination, such as a hotel or home, they can review, edit and ultimately approve the document that has already completed by the secretary, thus enabling the secretary to send the document on to the addressee, such as a client. Hours and days can therefore be saved in the document turnaround process.

As further shown in FIG. 17, other buttons on the telephone keypad 1700 can be used to review and edit the dictation. For example, using the keypad, the author can rewind 30 seconds, rewind 5 seconds, return to start, fast forward 30 seconds, fast forward 5 seconds, play back, stop, insert and overwrite a dictation.

Accordingly, the remote features of the system 200 enable dictation to be made and transcribed from any location. For example, if the author goes from Office A to Office B, and wants to send dictation back to a secretary at Office A, the author can log-in to any desktop at Office B and dictate to the Secretary at Office A instantly. The secretary automatically receives the dictation in the work in progress (WIP) inbox. There is no change required to the author's profile or settings, and workflow is unaffected by inter-office sharing.

In another example, if an author is traveling, and wants to dictate and send to a secretary, the author can use the telephony features to dictate immediately to the server and this will be automatically routed to his or her secretary and received in seconds. Alternatively the author can dictate into his or her laptop and upload the dictation via a wireless card. Also, using professional mobile devices, such as those available from Philips or Olympus which allows greater control of dictation, a document can be dictated, and the dictation can then be uploaded when at home, via a mobile card, or when the author is back in the office.

Table 13 below indicates examples of remote devices that can be used with the system 200.

| | Device Name |
|---|---|
| FIXED REMOTE | |
| Philips | Philips SpeechMike Classic |
| | record with button (USB and Serial) |
| | Philips SpeechMike Classic |
| | record with slider (USB) |
| | Philips SpeechMike Pro |
| | Trackball (USB end Serial) |
| | Philips DPM 9450i |
| | Philips DPM 9400i |
| Olympus | Olympus Voice Recorders DS-330 |
| | Olympus Voice Recorders DS-660 |
| | Olympus DS-4000 |
| Grundig | Grundig ProMike (later in 2005) |
| ROAMING REMOTE | |
| Philips | Philips DPM 9450i |
| | Philips DPM 9400i |
| | Philips DPM 9220 |
| | Philips DPM 9250 |
| | Philips DPM 9350 |
| Olympus | Olympus Voice Recorders DS-330 |
| | Olympus Voice Recorders DS-660 |
| | Olympus Voice Recorders DS-3000 |
| | Olympus DS-4000 |
| | Olympus DS-2200 |
| Grundig | Grundig Digta 4015 |
| Sanyo | Sanyo ICR-B130/ICR-B150 |
| Atis-Uher | UHER DH10 |
| TELEPHONY | Any touch tone phone |
| CITRIX | Citrix 1.8, XP, MPS3 or Terminal |
| | Service system |
| PDA | Any sound enabled PDA device. |

All remote devices synchronize automatically and quickly upon connection with the system 200. Software is source-code integrated with each device, allowing for more stability, and minimizing issues that can arise by installing third party device software. Furthermore, authors or secretaries can log onto the system 200 via VPN, Citrix, TS or standard dial-up and dictate or transcribe as they would in the office.

As can be appreciated by one skilled in the art, this feature also allows dictations to be created from a voice over IP (VOIP) enabled telephone system or a VOIP softphones for use over the Internet. In this regard, the telephony software includes a user customizable workflow engine that controls the prompts available at any stage, and a component that manages the VOIP call.

When a VOIP call is received, the system 200 authenticates the user with a user number and pin number. The user can control the recording of the dictation by playing, rewinding, fast forwarding and recording as well as changing from insert to overwrite mode. The user can set the priority and destination and then submit the dictation. Afterward, the user can either logout of the telephony system or record another dictation

As discussed above, a client device 202 or 206, for example, works in the same way whether it is online or offline. In the event of a network outage, authors and transcribers can continue working on the dictations they were busy with at the time of the disconnection. The following options help to mitigate the loss of workflow during an outage.

Dictations that are sent during a network or server outage will remain in the author's outbox until the connection becomes available. This is usually adequate for non-urgent dictations, as the author can continue creating and sending dictations. Transcribers who are disconnected are not prevented from working on dictations they have already opened. They can continue transcribing any dictations that are not listed as “pending” in their Work In Progress folders. New pending items will appear when the connection is restored. Also, authors can continue to work at their client device in the event of an outage. An author can export any dictation item to a sound file in .WAV format. If an urgent dictation is stuck in the Outbox because of a network failure, the author can recall the dictation and then export the file. An exported file can be passed to a transcriber an attachment to email, assuming that the email system is not affected by the outage, on a physical medium such as a floppy disk, USB memory stick or CD, or by copying the file to a shared network directory, assuming the network is not affected by the outage.

In addition, transcriber can plug a foot pedal and headset into an author's computer, change the control device options (e.g., Tools>Options . . . ) and transcribe dictations located in any visible folder. The transcriber must recall any dictations located in the author's Outbox before being able to transcribe them. An author who has access to a mobile dictation device can use the device to record dictations and then physically pass the device to the transcriber. The transcriber can connect headphones directly to the device before playing back the file.

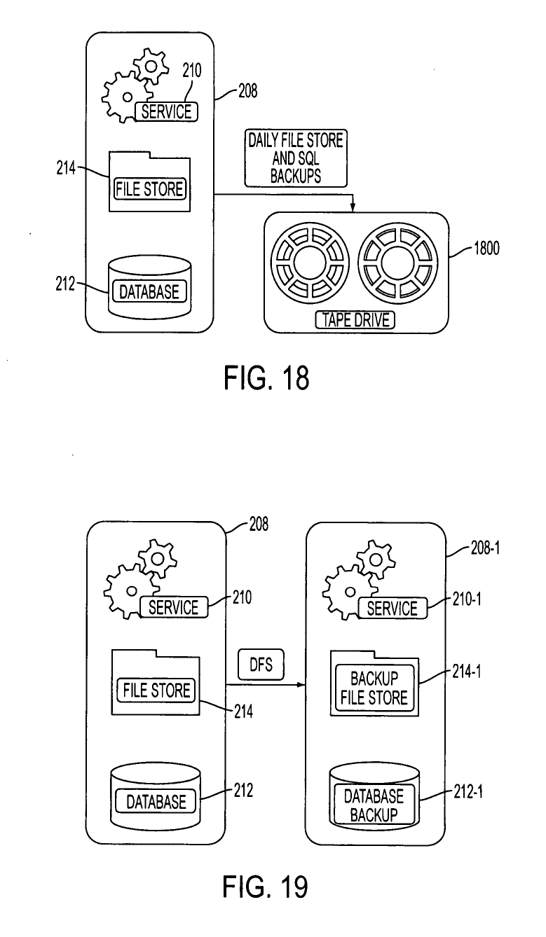

In addition to the above safeguards, a server 208 can run a daily backup of the file store and SQL database to a tape drive 1800, as shown in FIG. 18. This arrangement is easy to configure. In the event of the server file store 214 being lost, the server file store 214 could be repopulated from the client machines by importing any dictations the users had sent that day from that user's client device file store and then resubmit those dictations to the workflow.

Alternatively, as shown in FIG. 19, a single server 208 can run the software 210, file store 214 and SQL database 212. A secondary server 208 provides a backup dictation system. This arrangement allows for more frequent backups than the simple scenario and less data will be lost. After the initial configuration, backup will be automatic and will require less maintenance. The secondary server 208-1 maintains a secondary file store 214-1 in case the production server 208 fails. The backup of the file store 214 can employ, for example, a Microsoft Distributed File System (DFS), which Microsoft supplies with Windows 2000 Server. DFS makes a real-time duplicate of the audio files in the file store 214. When the production server 208 creates or deletes dictations, DFS automatically creates or deletes the corresponding audio files on the secondary storage (one or more shared network locations), thus providing the redundant file store 214-1. An SQL Enterprise Manager runs a maintenance plan to implement the database 212-1 backup. The database administrator configures the maintenance plan to run a scheduled backup at regular intervals throughout the day. Also, the database 212 can be restored from the most recent backup if the SQL server fails.

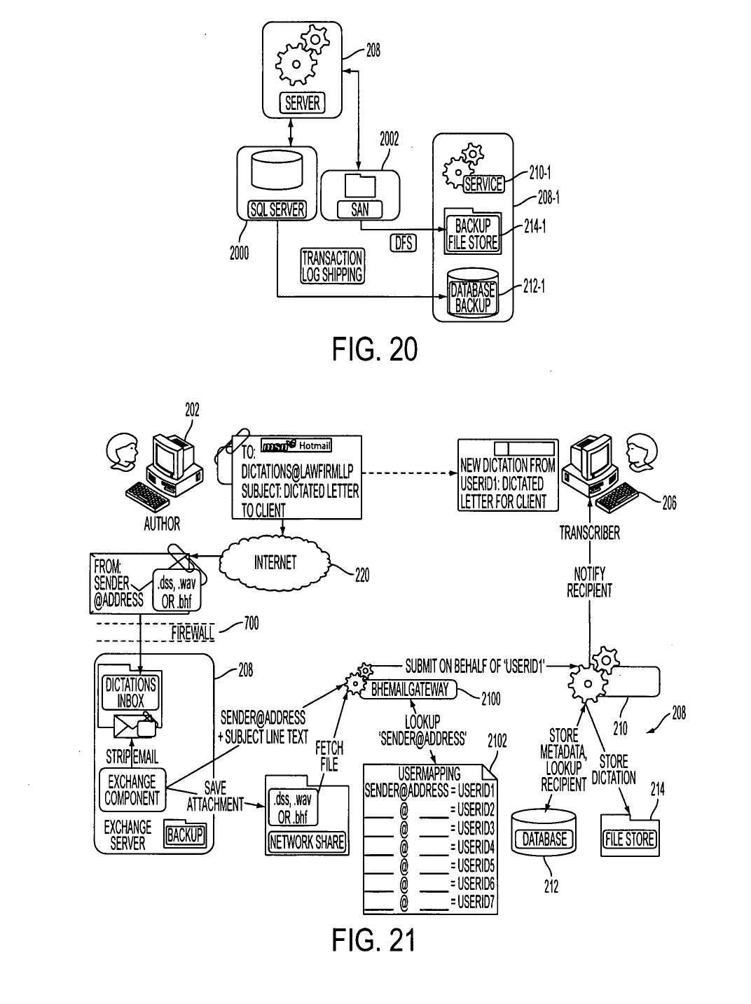

In another arrangement, as shown in FIG. 20, a secondary SQL server 208 backs up the primary server 208. This backup server also keeps a backup of the file store 214, so that if either the file store 214 or database 212 fails, the secondary server 208 ensures business continuity. DFS backs up the file store 214 as detailed in the previous scenario. There are two separate SQL databases 212 in this configuration. The secondary server 208-1 hosts a full backup of the database 212-1 and a SQL job regularly ships the transaction logs to this backup. This arrangement results in no or virtually no data loss.

As shown in FIG. 21, the system 200 further includes an email gateway 2100 that is a module which enables automatic submission of voice file attachments into the digital dictation workflow system. This is particularly useful for authors who are on the move and use mobile dictation devices. The email gateway enables submissions of dictations into the workflow from any computer that has an Internet connection, without the need for any client software. The Email Gateway does not require any changes to existing infrastructure, and operates with a Microsoft Exchange Server, for example, and server 208 to provide an additional option for the more flexible working patterns of authors. The email gateway can accept dictation attachments in the .bhf format, .wav format, and the digital speech standard .dss format. Thus, any device that can record voice into one of these formats can be used with the email gateway.

The email gateway 2100 in this example includes consists of three components. Specifically, an in-process component handling event notifications fired when email arrives at a specified Microsoft Exchange inbox, a daemon process monitoring a specified file store, and a client API for submitting dictations to the dictation server 208.

The component within the Exchange process implements the standard Exchange asynchronous events interface but minimizes its impact of the performance of Exchange by restricting its actions to extracting mail attachments to an external file store and then deleting the incoming email. The daemon process can utilize the standard Microsoft Windows file monitoring API. However this can be combined with the Exchange component to decouple the reception of email containing attached dictations from the downstream processing of those dictations by using a file store as a message queue external to Exchange. The daemon process can submit dictations to the dictation Server by calling a proprietary client API.

By combining these two standard Microsoft technologies with the proprietary client API, the email gateway enables users to initiate a fully automated submission of dictations with minimal impact on Exchange by simply sending an email containing that dictation to a specified email address.

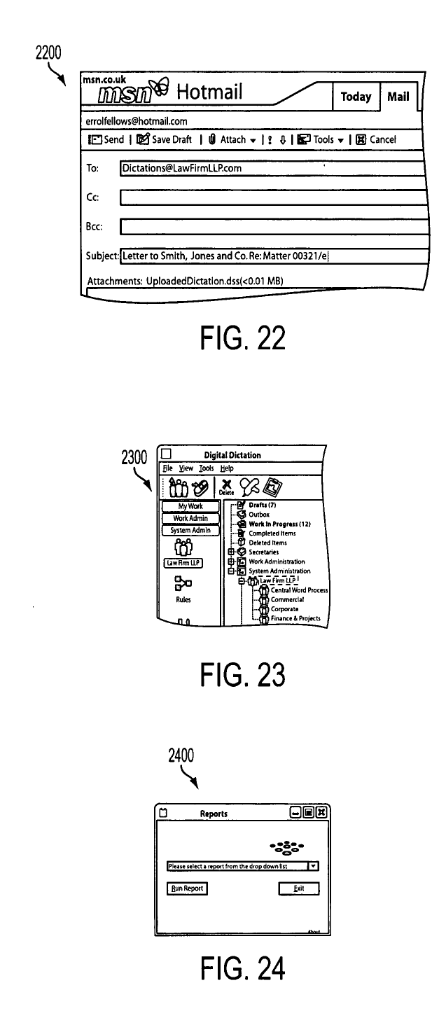

During operation, the dictation author can connect the digital dictation device to the computer 202, which Windows then recognizes as a storage device. The author composes a new email message in the web based or local email client program, such as Hotmail, GMail or Outlook Express, and then attaches the files from the connected device. The fee earner then enters the dictation email address, for example Dictations@LawFirmLLP.com as shown in the email window 2200 in FIG. 22, adds a descriptive subject line and sends the email. The email is received by the company's Exchange server and processed by the email gateway 2100. The system reads the sender's email address and submits the attached files for transcription on behalf of the sender. The subject line can be used to title the dictation.

Once the dictations are in the system 200, the person or team who would normally transcribe dictations from the author is immediately notified of the new dictation. This can happen in exactly the same way as if the author were dictating in the office. The subject line of the email is used as the title of the dictation, so the author can easily pass instructions to the transcriber. When an email with attached dictations arrives, the exchange component sends the subject line and the sender's email address to the email gateway service. The attachments are saved to a directory on the system 200.

This Windows service may be hosted on the exchange server 208, or another server 208 in the system 200. The service retrieves the attachments from the network directory and checks the name of the sender against a list of known email addresses and corresponding usernames. The email gateway service logs into the system 200 under a preconfigured user account, and then submits the attachments into the transcription workflow on behalf of the user whose username is found in the list of known email addresses. If the service can not find the sender's email address, it submits the dictations to a default workflow. This ensures that the author can use any email account to submit dictations. The default recipient has the ability to reassign work, ensuring that the dictation reaches the intended transcriber.

The system 200 further provides for visibility and transparency of management information on screen, rather than having to click through numerous call-outs or run historical analysis at every stage. The system 200 also allows total visibility of information across both departments and sites. Administrators, management and even users, if required, can browse immediately to find out information pertaining to a dictation such as priority, length, author, required by, title, matter no., date & time sent, completed, physical file, document type and password protection. They can also find out information pertaining to a user, such as the number of dictations outstanding, number of dictations in WIP, and all dictation profiles as stated above, as well as the total number of dictations outstanding for a group, and workflow settings, administration settings and permissions.

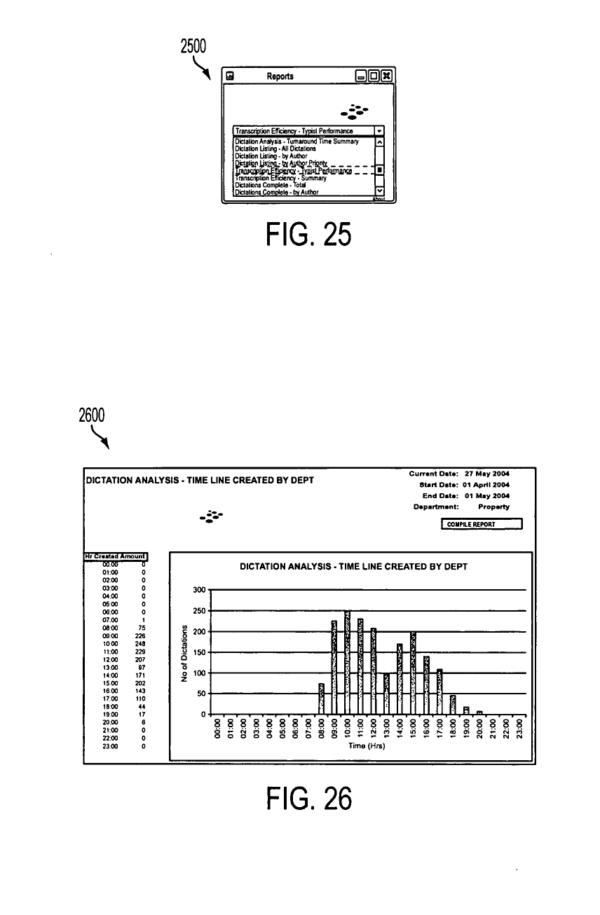

The system 200 also includes a “Report Wizard” which can be brought up via the Reporting icon by anyone with Reporting rights, such as a work or system administrator using the window 2300 as shown in FIG. 23. Clicking on the Reporting icon brings up the list of reports in a dialogue box 2400 as shown in FIG. 24 within one click. A user can also return to the main interface within one click. A drop down list displays all the reports 2500 as shown in FIG. 25. The user can clicks on the “Run Report” icon to generate the information essentially instantly. An example of the type of reports that can be generated is shown in Table 14 below

TABLE 14

| Report type | Report name |
|---|---|
| Administration | Administrators |
| | Department administrators |
| | Recipients of CWP dictations |
| | Recipients of department dictations |
| | User views by department |
| | User views by team |
| | User views by user |
| | Workflow analysis by author |
| | Workflow analysis by secretary |
| Dictation analysis | Dictation analysis by author |
| | Dictation analysis by author and department |
| | Dictation analysis by department |
| | Dictation analysts by secretary |
| | Dictation analysis by secretary and department |
| | Dictation analysis - time line completed/by user |
| | Dictation analysts - time line created/by dept |
| | Dictation break outside/inside department |
| | Dictation break out within department |
| | Dictation send utilisation |
| | Average dictation turn around time |
| | Dictation turn around time summary |
| Dictation listings | Dictation listing |
| | Dictation list by author |
| | Dictation list by author & priority |
| Secretary | Secretary performance |
| performance | |
| | Secretary performance summary |
| Complete dictation | Complete dictations |
| | Complete dictations by author |
| | Complete dictations by author & priority |
| | Complete dictations by secretary |
| In Progress | In Progress dictations |
| dictation | |
| | In Progress dictations breakdown |
| | in Progress dictations by secretary |
| | In Progress dictations by secretary & priority |
| Pending dictation | Pending dictations |
| | Pending dictations by priority |
| | Slow moving dictations |

The system 200 can use Microsoft Excel 2000 and Windows 2000/XP Professional to display standard or customized reports 2600, as shown in FIG. 26, which can easily be viewed and changed. The reports can be saved onto the SQL database 212, so that users can also run their own reports using specialist reporting packages such as Crystal, if desired and if they have internal expertise.

The system 200 further includes an open, clear and flexible alert and escalation system in order to promote a highly visible, sharing culture. In this example, the system 200 utilizes a “Priority Wizard” to enable users to set their own rules and actions for work deadlines. The Priority Wizard is intuitive and designed so that a user can make administrative changes quickly and universally.

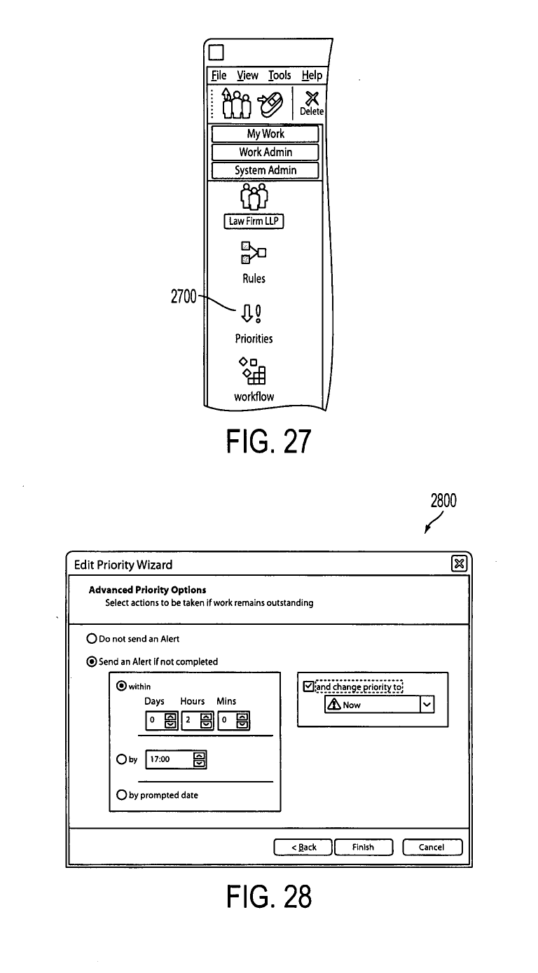

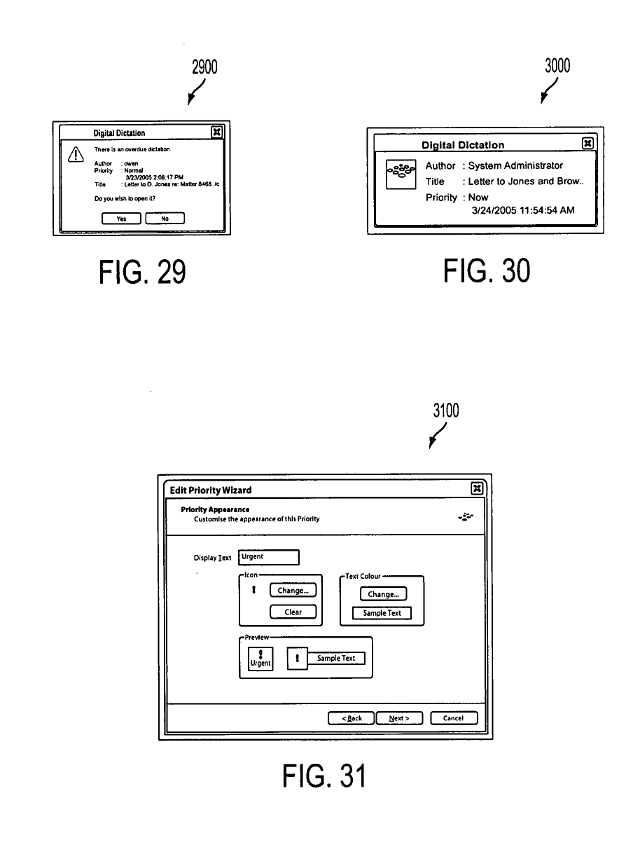

The system 200 in this example allows for three types of priority based escalation, with or without alarms. The system 200 uses a default “priority based” escalation, rather than a “document type” based system. The three types of alarms in this example are: send alarm without escalation within a number of days/hours/minutes, complete by (time), by prompted date (user); send alarm (as above) and escalate priority; and do not send alarm. For example, a user can view the buttons in the window 2700 as shown in FIG. 27 and click on the priorities icon to display the priority wizard window 2800 as shown in FIG. 28. The format of the alarm notification can also be configured depending on preference, whether it be a basic box alert 2900 as shown in FIG. 29 or a familiar XP Style Fade-out alert 3000 as shown in FIG. 30. The two alerts formats allow for the working culture of the secretaries to be taken into account, ensuring their modus operandi is not interrupted. The name of the Priority, along with its color and icon, can be configured to reflect familiar practices or names within the firm, as shown in the window 3100 in FIG. 31, to ensure user familiarity and speed of uptake.

As can further be appreciated from the above, the system 200 enables users, such as authors or transcribers, to submit dictations from the client devices, the telephony system or the email gateway and automatically route the dictation to third-party transcription companies. After submission, the author can monitor progress of the dictation until the work is complete and the transcribed document is held in the document management system. This application can include a single component that logs onto the server 208 as a secretarial. This component is notified when a new dictation is sent to the “transcription agency” sending option. The software downloads the dictation and ftps it along with a XML file containing dictation metadata to a location on a web server. When the state of the dictation changes the transcription company returns an XML file which is picked up by the software and used to change the state of the dictation, thus allowing the author to track the progress of the dictation.

Furthermore, a web client feature allows authors and secretaries access to their digital dictation workflow system from PCs running standard web browsers, which could possibly be situated in an internet café. Authors can upload dictations from remote recording devices such as the DPM 9450, create new dictations from the web client (possibly streaming sound to the server), and monitor the progress of dictations.

In addition, dictations to be recorded on Blackberries or on PDAs running Microsoft PocketPC. This enhances the software 210 by improving support for remote working and access. Authors will be able to control the recording of dictations so that they can record, rewind, fast forward and play as well as being able to insert or overwrite at any point in the recording. After completion of the dictation, the author submits the dictation and the software immediately transfers the dictation to the server 208 for routing to a transcriber for typing.

Furthermore, a meeting manager feature allows an organization to record meetings on a multi-track digital recorder so that each participant's contribution is recorded on a separate track. After the meeting the recording is digitally signed to guarantee that the recordings cannot be tampered with or repudiated. The recording can be exported to CD so that participants can take a copy of the recording away with them. This feature also provides for the ability mark sections of the new interview/meeting with a description or title. Attendee's in conference calls can be authenticated or tagged when they speak so that the recording could be used as evidence in court and to enable easy of transcription. The resultant recording would need to be digitally signed. The audio files are securely authenticated and tamper proof, and the software for this feature may integrate with document management system. The software may need to accommodate many (e.g., up to 30,000) meetings per year. Meetings may need to be kept online for a certain period (e.g., up to 7 years), with an indexing system to ensure the interviews can found and retrieved. Each meeting also can have associated profile data, or metadata, such as the attendees, date and location, which are searchable through the interface. The software is portable since meetings are on- or off-site. Also, any interviewee can receive an audio copy after the interview, and the copy should be playable on any device.

Although only a few exemplary embodiments of the present invention have been described in detail above, those skilled in the art will readily appreciate that many modifications are possible in the exemplary embodiments without materially departing from the novel teachings and advantages of this invention. For example, the order and functionality of the steps shown in the processes may be modified in some respects without departing from the spirit of the present invention. Accordingly, all such modifications are intended to be included within the scope of this invention.

What is claimed is:

1. A dictation system, comprising:
at least one first client device which is operable to record audio information dictated by a user for storing as a digital audio file;
at least one second client device which is operable to receive the stored digital audio file over a network for reproduction as audio; and
at least one server, connected to the first and second client devices via the network, and running software for managing storage and retrieval of the digital audio file to and from the first and second client devices.

2. A dictation system as claimed in claim 1, further comprising:
at least one file store, connected to the first and second client devices via the network, for storing the digital audio file under management of the server.

3. A dictation system as claimed in claim 2, wherein:
the second client device retrieves the digital audio file from the file store via the network under management of the server.

4. A dictation system as claimed in claim 2, further comprising:
at least one database for storing dictation data pertaining to the digital audio file stored in the file store.

5. A dictation system as claimed in claim 4, wherein:
the first and second client devices are present in a presentation layer, the server is present in a business logic layer, and the file store and database are present in a data access layer.

6. A dictation system as claimed in claim 1, further comprising:
a plurality of first and second client devices, with each of the first client devices being operable to receive multiple said audio information for storing as multiple respective digital audio files and to perform the editing operations on any of the respective stored digital audio files, and each of the second client devices is operable to receive any of said digital audio files.

7. A dictation system as claimed in claim 6, wherein:
the server is operable to provide the respective digital audio files to particular second client device based on criteria pertaining to those particular second client devices.

8. A dictation system as claimed in claim 1, wherein:
the first client device is operable to display a recording window to enable the user to control the recording and editing of the digital audio file.

9. A dictation system as claimed in claim 1, wherein:
the first client device is further operable to edit the digital audio file by performing at least one of the following editing operations:
recording further audio information dictated by the user and storing the further audio information as further digital information at a location within the stored digital audio file between the beginning and end of the stored digital file; and
deleting a portion of the stored digital audio file other than the entirety of the digital audio file as directed by the user; and

10. A dictation system as claimed in claim 1, wherein:
the first client device is controllable remotely by telephone, such that the first client device performs the respective recording and editing operations in response to depression of respective keys on the telephone.

11. A method for operating a dictation system comprising at least one first client device, at least one second client device and at least one server connected to the first and second client devices via a network, the method comprising:
operating the first client device to record audio information dictated by a user for storing as a digital audio file;
operating the second client to receive the stored digital audio file over a network for reproduction as audio; and
operating the server to manage storage and retrieval of the digital audio file to and from the first and second client devices.

12. A method as claimed in claim 11, further comprising:
operating the server to manage storage and retrieval of the digital audio file to and from at least one file store connected to the first and second client devices via the network.

13. A method as claimed in claim 12, wherein:
operating the second client device to retrieve the digital audio file from the file store via the network under management of the server.

14. A method as claimed in claim 12, further comprising:
operating the server to store in at least one database dictation data pertaining to the digital audio file stored in the file store.

15. A method as claimed in claim 14, further comprising:
the first and second client devices are present in a presentation layer, the server is present in a business logic layer, and the file store and database are present in a data access layer.

16. A method as claimed in claim 11, wherein:
the dictation system comprises a plurality of first and second client devices; and
the method further comprises:
operating each of the first client devices to receive multiple said audio information for storing as multiple respective digital audio files; and
operating each of the second client devices receive any of said digital audio files.

17. A method as claimed in claim 16, further comprising:
operating the server to provide the respective digital audio files to particular second client device based on criteria pertaining to those particular second client devices.

18. A method as claimed in claim 11, further comprising:
operating the first client device to display a recording window to enable the user to control the recording and editing of the digital audio file.

19. A method as claimed in claim 11, further comprising operating the first client device to edit the digital audio file by performing at least one of the following editing operations:
recording further audio information dictated by the user and storing the further audio information as further digital information at a location within the stored digital audio file between the beginning and end of the stored digital file; and
deleting a portion of the stored digital audio file other than the entirety of the digital audio file as directed by the user; and

20. A method as claimed in claim 11, further comprising:
controlling the first client device remotely by telephone, such that the first client device performs respective recording and editing operations on the digital audio file in response to depression of respective keys on the telephone.
